(19) United States
(12) Patent Application Publication
(10) Pub. No.: US 2014/0224373 A1
(43) Pub. Date: Aug. 14, 2014

(54) LAY-FLAT HOSE FOR OILFIELD HYDRAULIC FRACTURING OPERATIONS

(71) Applicant: MPS Enterprises, Inc., Midland, TX (US)

(72) Inventor: Billy Scott Brown, Houston, TX (US)

(73) Assignee: MPS Enterprises, Inc., Midland, TX (US)

(21) Appl. No.: 14/179,377

(22) Filed: Feb. 12, 2014

Related U.S. Application Data
(60) Provisional application No. 61/763,786, filed on Feb. 12, 2013.

(51) Int. Cl. F16L 11/12

(52) U.S. Cl. CPC F16L 11/12
USPC 138/119

(57) ABSTRACT

A lay-flat hose is manufactured by single-extrusion of rubber through a cylindrical polyester weave jacket to limit swelling and expansion upon pressurization. Forcing the rubber compound through the weave creates a single homogenous construction without the use of glues or adhesives. The lay-flat hose is lightweight and durable.

### STATEMENT OF RELATED APPLICATION

This application depends from and claims priority to U.S. Provisional Application No. 61/763,786 filed on Feb. 12, 2013.

### FIELD OF THE INVENTION

The present invention relates to hoses used in the oilfield industry and, more particularly, the present invention relates to an improved lay-flat hose that is suitable for use in hydraulic fracturing operations.

### BACKGROUND OF THE INVENTION

The oil and gas industry commonly uses lengths of rigid pipe to transfer fluid from one location, such as a mud pit, to another location, such as a mixing tank or a wellhead. The rigid pipe is typically used for several weeks or months, and is commonly moved from a first location to a new location once there is no longer a need for the pipe at the first location.

In recent years, lay-flat hose has been proposed for use in hydraulic fracturing operations, referred to herein as “fracing operations,” and as disclosed in U.S. Patent Publication 2012/0118397. While lay-flat hose has advantages over rigid pipe, further improvements in lay-flat hose are required for such hoses to be more widely accepted in the oil and gas industry.

The disadvantages of the prior art are overcome by the present invention, an improved lay-flat hose for oilfield operations is hereinafter disclosed.

### BRIEF DESCRIPTION OF THE DRAWINGS

FIG. 1 is cross-sectional view of a lay-flat hose.

FIG. 2 is cross-sectional view of a sidewall of the lay-flat hose.

FIG. 3 is a cross-sectional view depicting two lay-flat hoses connected by a crimped fitting.

### DETAILED DESCRIPTION OF PREFERRED EMBODIMENTS

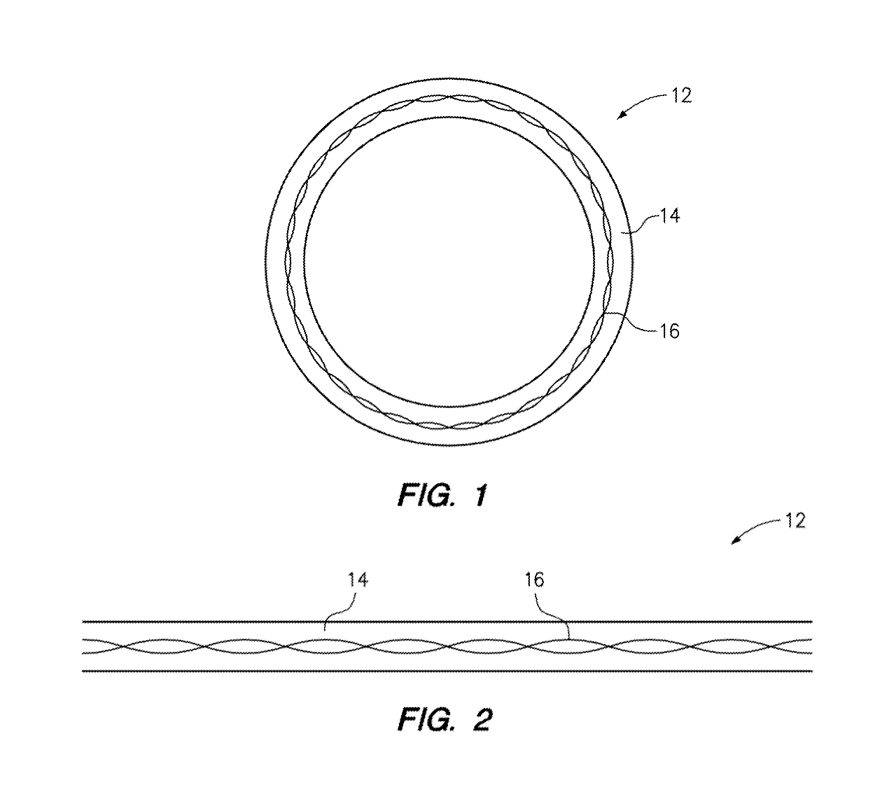

The lay-flat hose of the present invention has significant advantages over conventional rigid pipe, and has several advantages over prior art lay-flat hoses. As shown in FIGS. 1 and 2, the hose 12 of the present invention is a single extrusion hose, meaning that in a single extrusion process, the nitrile rubber 14 is extruded through the polyester jacket 16 that forms the cylindrical shape of the hose. Forcing the rubber compound through the weave creates a single homogenous construction without the use of glues or adhesives.

A preferred material composition for the lay-flat hose of the present invention is 70% nitrile rubber and 30% PVC. Alternatively, polyurethane may be used instead of nitrile rubber. Polyurethane is known for swelling similar to a double extrusion nitrile rubber hose, and polyurethane is typically more expensive than nitrite rubber. Sealing of a polyurethane hose also may cause the hose to rupture on the fitting band. PVC material does not have the abrasion resistance that nitrile rubber provides, and PVC is too fragile for many oilfield applications.

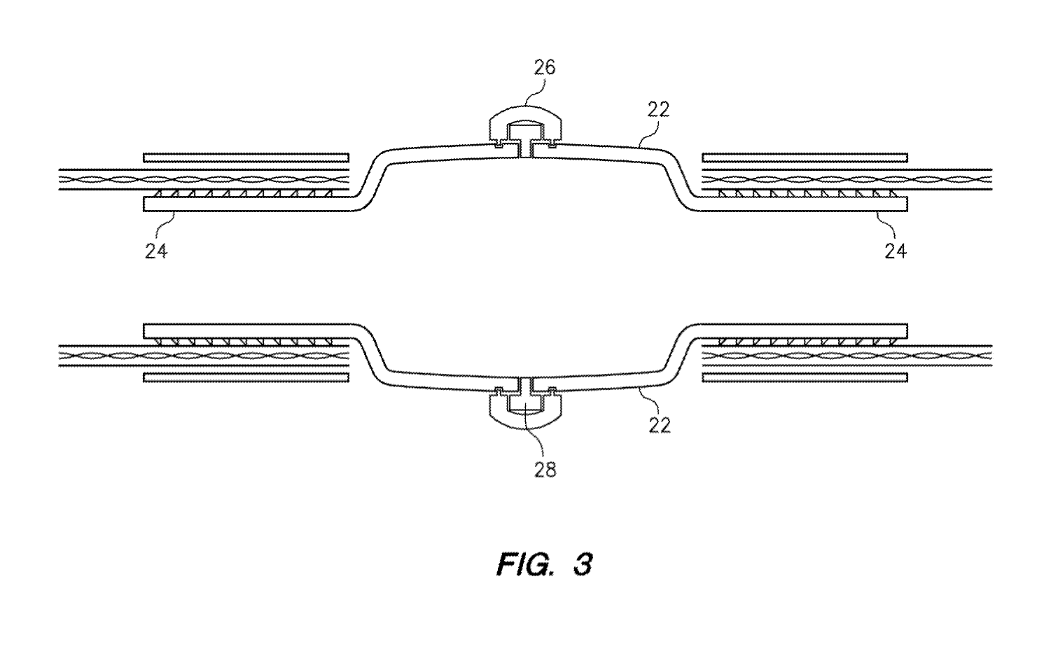

In order to connect ends of the hose, Applicant provides a crimped fitting 22, also shown in FIG. 3, that includes a steel sleeve 24 at each end that provides complete hose contact to the exterior surface of the fitting. The sleeve 24 provides complete contact with the fitting. A conventional crimping machine may be used to press the sleeve 24 over the end of the hose 12 to provide a leak free connection. The steel sleeve may have a unique serial number so that the band can be identified in the event of failure. A standard Victaulic™ clamp 26 and seal 28 sealingly connect the adjoining sleeves 22. An alternative technique uses a banded fitting, which provides less complete contact between the hose and fitting, and may be more likely to fail.

The present hose incorporates a polyester weave jacket, while prior art lay-flat hoses frequently use a steel jacket. The hose is thus more lightweight than the alternative steel jacket hose. The present hose does not require any sort of machining for deployment, and the hose can be placed on the deck in a flat-bed trailer so that the hose feeds out of the trailer as it drives away. The hose couplings are also preferably connected while the hose is still on the trailer. This allows for much faster deployment, and one does not have to stop to put on a coupling every time the new length of hose is deployed.

As discussed above, the lay-flat hose is manufactured by extruding rubber through a cylindrical polyester weave jacket. The hose may be used for liquid transfer from a frac pit to a drill site, and then back to the frac pit. In addition to substantial cost and labor required for conventional pipe to perform these tasks, a lay-flat hose offers rapid deployment. The hose may come in lengths in excess of 600 feet so that installing one mile of flat hose takes less than 30 minutes.

While conventional rigid pipe used in fracturing operations frequently leaks, the lay-flat hose is virtually leak proof. Since some of the liquids that arise from the drilling site during fracing may be hazardous to the environment, the hose of this fracing system is contained and leak-free, thereby reducing environmental concerns.

A single extrusion hose is less prone to excessive swelling and elongation than prior art double extrusion hoses. Double extrusion hoses can swell up to 20% of the original size, which causes the hose to slowly cut itself on the bands that secure the hose fittings. The double extrusion hose also tends to grow or elongate. Once the hose is put under an exemplary operating pressure of 150 psi the hose can grow up to 10% lengthwise. In a normal fracing operation, there is a liquid pump at one end of the lay-flat hose and a frac storage tank connected to the other end. If the hose becomes 10% longer under pressure, the hose can damage the pump.

The single extrusion hose according to the present invention has an elongation factor of 4% or less and a swell factor of less than 5%. The single extrusion hose is much more manageable with these factors.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

We claim:

1. A lay-flat hose for use in pumping liquids, comprising:
the hose formed from a nitrile rubber compound and a polyester weave placed between an interior surface and an exterior surface of the nitrile rubber compound, the hose being to lay-flat hose such that the hose collapses to a substantially flat configuration when pressurized fluid is not transmitted through the hose and the hose expands to a substantially circular cross-sectional configuration when pressurized fluid is transmitted through the hose.

2. The lay-flat hose as defined in claim 1, further comprising:
a crimp fitting for connecting adjacent ends of the hose, the crimp fitting including a steel sleeve which grippingly engages the interior surface of the lay-flat hose, the crimp fitting ends being connected by a coupling.

3. The lay-flat hose as defined in claim 1, wherein the hose has an elongation of less than 4% when subjected to pressurized fluid of 150 psi.

4. The lay-flat hose as defined in claim 1, wherein the hose has a swell factor of less than 5% when subjected to pressurized fluid of 150 psi.
